(19) United States
(12) Patent Application Publication
(10) Pub. No.: US 2016/0034170 A1
(43) Pub. Date: Feb. 4, 2016

(54) SEARCH USING HANDWRITING TO INVOKE MULTI-WINDOW SEARCH RESULT SCREEN

(71) Applicant: Sony Corporation, Tokyo (JP)

(72) Inventors: Jesse Gallup, San Marcos, CA (US); Kenji Ozawa, Kawasaki (JP)

(21) Appl. No.: 14/448,088

(22) Filed: Jul. 31, 2014

(51) Int. Cl. G06F 3/0488; G06F 17/27; G06F 17/30; G06F 3/0484; G06F 3/0481

(52) U.S. Cl. CPC G06F 3/04883; G06F 3/04847; G06F 3/0481; G06F 17/30657; G06F 17/2765

(57) ABSTRACT

A user can transition a computer from a reduced power mode to a higher power mode by inputting handwriting gestures on a touchscreen display of the computer. As well, the gestures are processed using a handwriting recognition engine and the result is used to query multiple sources of information including the Internet and local data storage on the computer. The search results are presented in partitioned windows on the display according to the sources of information queried.

### FIELD OF THE INVENTION

The application relates generally to search using handwriting to invoke a multi-window search result screen.

### BACKGROUND OF THE INVENTION

A computer ecosystem, or digital ecosystem, is an adaptive and distributed socio-technical system that is characterized by its sustainability, self-organization, and scalability. Inspired by environmental ecosystems, which consist of biotic and abiotic components that interact through nutrient cycles and energy flows, complete computer ecosystems consist of hardware, software, and services that in some cases may be provided by one company, such as Sony. The goal of each computer ecosystem is to provide consumers with everything that may be desired, at least in part services and/or software that may be exchanged via the Internet. Moreover, interconnectedness and sharing among elements of an ecosystem, such as applications within a computing cloud, provides consumers with increased capability to organize and access data and presents itself as the future characteristic of efficient integrative ecosystems.

Two general types of computer ecosystems exist: vertical and horizontal computer ecosystems. In the vertical approach, virtually all aspects of the ecosystem are owned and controlled by one company, and are specifically designed to seamlessly interact with one another. Horizontal ecosystems, one the other hand, integrate aspects such as hardware and software that are created by other entities into one unified ecosystem. The horizontal approach allows for greater variety of input from consumers and manufactures, increasing the capacity for novel innovations and adaptations to changing demands.

### SUMMARY OF THE INVENTION

An example ecosystem that is pertinent here is an entertainment ecosystem in the home that includes a primary display that may be used to search other repositories of data to respond to user queries. Currently, users must login to a search device then navigate to search before beginning search. Using present principles, a user can initiate a search from a device that is in a reduced power mode by simply writing search phrases on a display of the device. As disclosed in greater detail below, in a reduced power or standby mode, upon detecting writing on a touchscreen, either the device's basic input-output (BIOS)/embedded controller (EC) launches a search mode. Instead of BIOS/EC a digitizer, an additional microcontroller (MCU), or toggling a custom button to launch writing search (like ASSIST button) may be used for this purpose. Or, a general purpose input/output (GPIO) map may be used. In some examples, upon receiving the handwriting a face recognition engine may be invoked to compare an image of the user's face as captured by a camera of the device to a template image or images prior to initiating a search.

Accordingly, a computing device is disclosed that includes a computer readable storage medium bearing instructions executable by a processor, and at least one processor configured for accessing the computer readable storage medium to execute the instructions to configure the processor for establishing a reduced power state of the device. The instructions when executed by the processor configure the processor for receiving gesture signals from a display of the device, and responsive to the gesture signals, establishing an increased power state of the device. Also, the instructions when executed by the processor configure the processor for, responsive to the gesture signals, generating a query, sending the query to at least a first source of information, and presenting at least portions of a response to the query from the first source of information on the display.

In example embodiments the instructions when executed by the processor configure the processor for sending the query to at least a second source of information, and presenting at least portions of a response to the query from the second source of information on the display. The portions of the response to the query from the first source of information are presented in a first partition on the display and the portions of the response to the query from the second source of information are presented in a second partition on the display different from the first partition.

In still further examples, the instructions when executed by the processor configure the processor for sending the query to at least a third source of information, and presenting at least portions of a response to the query from the third source of information on the display.

The first source of information may be the Internet. The second source of information can be a digital data storage element in the device. The third source of information can be a database of computer software applications.

In another aspect, a computer device includes at least one computer readable storage medium bearing instructions executable by a processor, and at least one processor configured for accessing the computer readable storage medium to execute the instructions to configure the processor for presenting on a display of the device a user interface (UI). The UT presents search results from plural sources of information in respective windows on the display responsive to a query sent to the sources of information. A first source can be the Internet and a second source may be an internal data storage of the device.

In another aspect, a method of operating a computer device having a processor, memory, and a touchscreen is disclosed. The method establishes an increased power state of the device in response to an initial user input, and generates a query in response to received user input at the touchscreen. The query is sent to one or more sources of information, and at least a portion of their responses are displayed on the touchscreen.

In example embodiments, the responses from multiple sources of information are displayed in multiple windows on the touchscreen display.

The details of the present invention, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in accordance with present principles;

FIG. 2 is a flow chart showing example logic according to present principles;

FIGS. 3 and 4 are sequences of example screen shots illustrating present principles; and

FIG. 5 is a schematic illustrating operation of an example system in accordance with present principles.

### DETAILED DESCRIPTION

This disclosure relates generally to computer ecosystems including aspects of consumer electronics (CE) device based user information in computer ecosystems. A system herein may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google. These operating environments may be used to execute one or more browsing programs, such as a browser made by Microsoft or Google or Mozilla or other browser program that can access web applications hosted by the Internet servers discussed below.

Servers may include one or more processors executing instructions that configure the servers to receive and transmit data over a network such as the Internet. Or, a client and server can be connected over a local intranet or a virtual private network. A server or controller may be instantiated by a game console such as a Sony Playstation (trademarked), a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

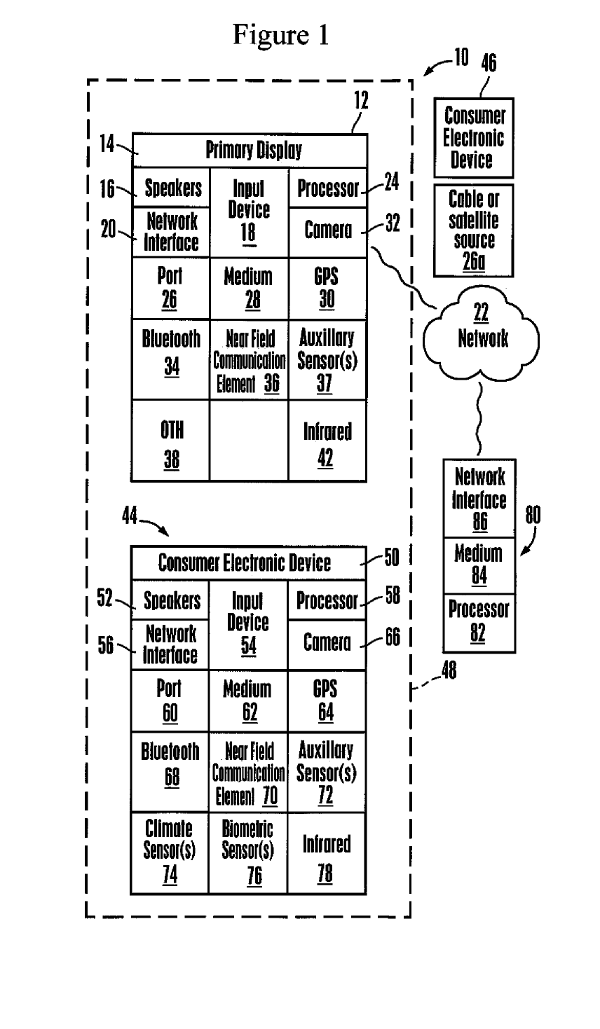

Now specifically referring to FIG. 1, an example ecosystem 10 is shown, which may include one or more of the example devices mentioned above and described further below in accordance with present principles. The first of the example devices included in the system 10 is an example primary display device, and in the embodiment shown is an audio video display device (AVDD) 12 such as but not limited to an Internet-enabled TV with a TV tuner. Thus, the AVDD 12 alternatively may be an appliance or household item, e.g. computerized Internet enabled refrigerator, washer, or dryer. The AVDD 12 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVDD 12 is configured to undertake present principles (e.g. communicate with other CE devices to undertake present principles, execute the logic described herein, and perform any other functions and/or operations described herein).

Accordingly, to undertake such principles the AVDD 12 can be established by some or all of the components shown in FIG. 1. For example, the AVDD 12 can include one or more displays 14 that may be implemented by a high definition or ultra-high definition “4K” or higher flat screen and that may be touch-enabled for receiving user input signals via touches on the display. The AVDD 12 may include one or more speakers 16 for outputting audio in accordance with present principles, and at least one additional input device 18 such as e.g. an audio receiver/microphone for e.g. entering audible commands to the AVDD 12 to control the AVDD 12. The example AVDD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface. It is to be understood that the processor 24 controls the AVDD 12 to undertake present principles, including the other elements of the AVDD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVDD 12 may also include one or more input ports 26 such as, e.g., a high definition multimedia interface (IMMO port or a USB port to physically connect (e.g. using a wired connection) to another CE device and/or a headphone port to connect headphones to the AVDD 12 for presentation of audio from the AVDD 12 to a user through the headphones. For example, the input port 26 may be connected via wire or wirelessly to a cable or satellite source 26a of audio video content. Thus, the source 26a may be, e.g., a set top box, or a satellite receiver. Or, the source 26a may be a game console or disk player containing content that might be regarded by a user as a favorite for channel assignation purposes described further below.

The AVDD 12 may further include one or more tangible computer readable storage medium 28 such as disk-based or solid state storage, in some cases embodied in the chassis of the AVDD as standalone devices or as a personal video recording device (PVR) or video disk player either internal or external to the chassis of the AVDD for playing back AV programs. Also in some embodiments, the AVDD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVDD 12 is disposed in conjunction with the processor 24. However, it is to be understood that that another suitable position receiver other than a cellphone receiver, GPS receiver and/or altimeter may be used in accordance with present principles to e.g. determine the location of the AVDD 12 in e.g. all three dimensions.

Continuing the description of the AVDD 12, in some embodiments the AVDD 12 may include one or more cameras 32 that may be, e.g., a thermal imaging camera, a digital camera such as a webcam, and/or a camera integrated into the AVDD 12 and controllable by the processor 24 to gather pictures/images and/or video in accordance with present principles. Also included on the AVDD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVDD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the processor 24. The AVDD 12 may include an over-the-air TV broadcast port 38 for receiving OTH TV broadcasts providing input to the processor 24. In addition to the foregoing, it is noted that the AVDD 12 may also include an infrared (IR) transmitter and/or IR receiver and/or IR transceiver 42 such as an IR data association (IRDA) device. A battery (not shown) may be provided for powering the AVDD 12.

Still referring to FIG. 1, in addition to the AVDD 12, the system 10 may include one or more other CE device types. In one example, a first CE device 44 may be used to control the display via commands sent through the below-described server while a second CE device 46 may include similar components as the first CE device 44 and hence will not be discussed in detail. In the example shown, only two CE devices 44, 46 are shown, it being understood that fewer or greater devices may be used.

In the example shown, to illustrate present principles all three devices 12, 44, 46 are assumed to be members of an entertainment network in, e.g., a home, or at least to be present in proximity to each other in a location such as a house. However, for illustrating present principles the first CE device 44 is assumed to be in the same room as the AVDD 12, bounded by walls illustrated by dashed lines 48.

The example non-limiting first CE device 44 may be established by any one of the above-mentioned devices, for example, a portable wireless laptop computer or notebook computer, and accordingly may have one or more of the components described below. The second CE device 46 without limitation may be established by a video disk player such as a Blu-ray player, a game console, and the like. The first CE device 44 may be a remote control (RC) for, e.g., issuing AV play and pause commands to the AVDD 12, or it may be a more sophisticated device such as a tablet computer, a wireless telephone, etc.

Accordingly, the first CE device 44 may include one or more displays 50 that may be touch-enabled for receiving user input signals via touches on the display. The first CE device 44 may include one or more speakers 52 for outputting audio in accordance with present principles, and at least one additional input device 54 such as e.g. an audio receiver/microphone for e.g. entering audible commands to the first CE device 44 to control the device 44. The example first CE device 44 may also include one or more network interfaces 56 for communication over the network 22 under control of one or more CE device processors 58. Thus, the interface 56 may be, without limitation, a Wi-Fi transceiver, which is an example of a wireless computer network interface. It is to be understood that the processor 58 controls the first CE device 44 to undertake present principles, including the other elements of the first CE device 44 described herein such as e.g. controlling the display 50 to present images thereon and receiving input therefrom. Furthermore, note the network interface 56 may be, e.g., a wired or wireless modem or router, or other appropriate interface such as, e.g., a wireless telephony transceiver, or Wi-Fi transceiver as mentioned above, etc.

In addition to the foregoing, the first CE device 44 may also include one or more input ports 60 such as, e.g., a HDMI port or a USB port to physically connect (e.g. using a wired connection) to another CE device and/or a headphone port to connect headphones to the first CE device 44 for presentation of audio from the first CE device 44 to a user through the headphones. The first CE device 44 may further include one or more tangible computer readable storage medium 62 such as disk-based or solid state storage. Also in some embodiments, the first CE device 44 can include a position or location receiver such as but not limited to a cellphone and/or GPS receiver and/or altimeter 64 that is configured to e.g. receive geographic position information from at least one satellite and/or cell tower, using triangulation, and provide the information to the CE device processor 58 and/or determine an altitude at which the first CE device 44 is disposed in conjunction with the CE device processor 58. However, it is to be understood that that another suitable position receiver other than a cellphone and/or GPS receiver and/or altimeter may be used in accordance with present principles to e.g. determine the location of the first CE device 44 in e.g. all three dimensions.

Continuing the description of the first CE device 44, in some embodiments the first CE device 44 may include one or more cameras 66 that may be, e.g., a thermal imaging camera, a digital camera such as a webcam, and/or a camera integrated into the first CE device 44 and controllable by the CE device processor 58 to gather pictures/images and/or video in accordance with present principles. Also included on the first CE device 44 may be a Bluetooth transceiver 68 and other Near Field Communication (NFC) element 70 for communication with other devices using Bluetooth and/or NFC technology, respectively. An example NFC element can be a radio frequency identification (RFID) element.

Further still, the first CE device 44 may include one or more auxiliary sensors 72 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the CE device processor 58. The first CE device 44 may include still other sensors such as e.g. one or more climate sensors 74 (e.g. barometers, humidity sensors, wind sensors, light sensors, temperature sensors, etc.) and/or one or more biometric sensors 76 providing input to the CE device processor 58. In addition to the foregoing, it is noted that in some embodiments the first CE device 44 may also include an infrared (IR) transmitter and/or IR receiver and/or IR transceiver 42 such as an IR data association (IRDA) device. A battery (not shown) may be provided for powering the first CE device 44. The CE device 44 may communicate with the AVDD 12 through any of the above-described communication modes and related components.

The second CE device 46 may include some or all of the components shown for the CE device 44.

Now in reference to the afore-mentioned at least one server 80, it includes at least one server processor 82, at least one tangible computer readable storage medium 84 such as disk-based or solid state storage, and at least one network interface 86 that, under control of the server processor 82, allows for communication with the other devices of FIG. 1 over the network 22, and indeed may facilitate communication between servers and client devices in accordance with present principles. Note that the network interface 86 may be, e.g., a wired or wireless modem or router, Wi-Fi transceiver, or other appropriate interface such as, e.g., a wireless telephony transceiver.

Accordingly, in some embodiments the server 80 may be an Internet server, and may include and perform “cloud” functions such that the devices of the system 10 may access a “cloud” environment via the server 80 in example embodiments. Or, the server 80 may be implemented by a game console or other computer in the same room as the other devices shown in FIG. 1 or nearby.

According to present principles, the AVDD 12 may be controlled to enter an energy-saving mode (commonly referred to as a “sleep” state) after a predetermined event such as a period of non-use or a direct command to go to sleep input by a user. A user by moving a finger or stylus against the display 14 may input gestures that (1) awaken the AVDD, i.e., cause the AVDD to enter a full power mode, and (2) are interpreted as handwriting, if need be by the processor when other parts of the AVDD are in the sleep mode. The handwriting when done to awaken the AVDD may be interpreted as query that is sent to other devices such as to cloud servers 80 and the query (and attendant search results) are refined after each letter is written anywhere on the display. The search results may contain device-specific results across all searchable categories in real time. For example, when searching with a particular type or brand of portable computer, the search results that are returned may be from the Web, a contact list from storage 28 internal to the AVDD, applications executable by the AVDD, files on the internal storage 28, and multimedia files or links for video on demand, music, etc.

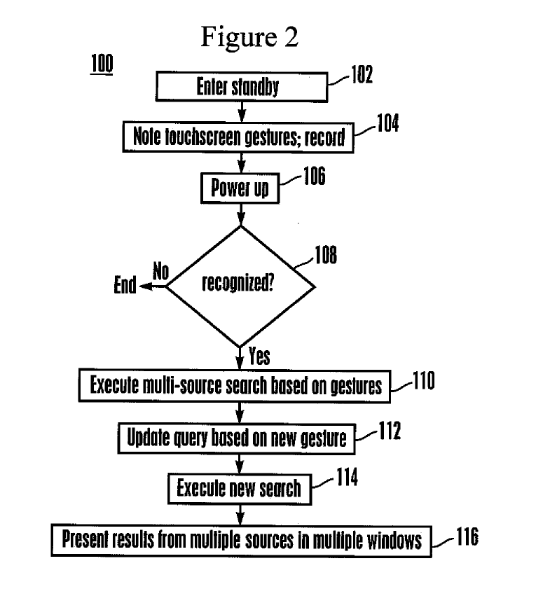

Referring now to FIG. 2, a flow chart of an example method of using handwriting to invoke a multi window search result screen is shown. This may be implemented by a computer device 12 such as that described with reference to FIG. 1 for example, in which the processor 24 executes software code instructions in order to implement the method. However any suitable computer device implementation may alternatively be used. In the method 100, the computer device such as an audio video display device (AVDD) 12 enters a standby or reduced power state at step 102. This “sleep” or energy saving mode may be implemented in a number of ways, for example by reducing or switching off power to a display 14, reducing or switching off power to various auxiliary modules such as Bluetooth 34 and GPS 30, reducing power to the processor 24, or any combination of these.

In such a reduced power state, the device may still be powered up by one or more trigger events as will be appreciated by those skilled in the art. An example power up trigger is detection of gestures or user input at the touch screen display 14. Such gestures or detectable interactions with the touch screen may include physical contact with or proximity of user digits or a stylus for example. In response to detecting such gestures or another suitable initial user input at step 104, the computer device is configured to establish an increased power state at step 106, which may include restoring full power to the processor and display screen for example.

At step 108, the device attempts to recognize the gestures for example using a handwriting recognition engine, and if unsuccessful ends the algorithm at this point. Without further user input the device will then typically return to the sleep state following a predetermined period of no user input. This situation may occur if the user accidentally touches the screen without intending to utilize the device for example. If however, gesture signals or appropriate user input is recognized at the touch screen display, in response the method executes a multi-source search based on the recognized gestures at step 110. This may take the form of generating a query based on the recognized gesture. The query may take the form of pre-determined request messages containing the recognized gesture, letter, number of other symbol, which are then sent according to one or more communications protocols to one or more sources of information.

The sources of information may comprise content and associated metadata, as well as other data that may be of interest to a user of the device. The information source will also typically comprise a query engine arranged to receive and respond to queries about the information stored thereon. For example an information source may comprise the intemet, including search engines, websites, social networking applications, content provider services and the like. A second information source may comprise a database of computer software applications, for example stored on a home personal computer. Further information sources may comprise a home entertainment system, other home based computer devices 12, as well as information stored on the local memory of the primary device 12.

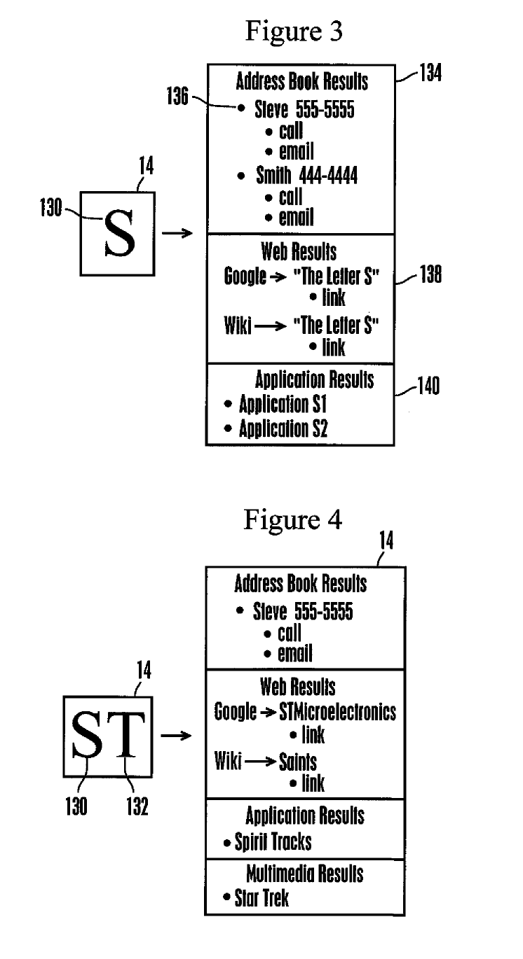

Referring to FIG. 3, a first recognized gesture or symbol 130 is shown on the touch screen display 14. The received gesture signals or user input have in this example been recognized as the letter “S”. A query containing this letter is then forwarded to a plurality of information sources, for example the internal memory of the computer device 12, an internet based search engine 80, a Wi-Fi connected second computing device 44. Each of these sources of information send a response to the query which may include details of contents associated with the recognized gesture as illustrated in FIG. 3. In a first window or partition 134 of the display 14, address book results 136 are displayed from the internal memory from the computer device 12. In a second window or partition 138 of the display, web results from search engines and other information sources are displayed. In a further partition 140, the response from a database of computer software applications is shown. In each case, the response may be processed by the computer device such that only a portion of the response is displayed. This portioning of the response may be based simply on size limitations of the display screen partition or may be based on intelligent filtering for example.

Referring again to FIG. 2, as further gesture signals are received from the touch screen display, the query is updated based on the new gesture at step 112. A new search is executed at step 114, by sending an updated query to the information sources and receiving their respective responses. At step 116, the updated responses, if any, are displayed on the touch screen display in respective windows or partitions. This updating process is illustrated in FIG. 4 in which a second symbol 132 is recognized as the letter “T”. An updated query containing “ST” is forwarded to the information sources which respond with more focused results as shown. For example the address book results are reduced to “Steve”, the former “Smith” from FIG. 3 no longer corresponding to the “ST” query. An additional window or partition is shown in FIG. 4 which displays multimedia results from a home entertainment information source for example. As will appreciated, the recognition of further symbols or gesture signals at the touch screen display will result in a further query or search with more focused or filtered results displayed to the user in the multi window result screen.

This example embodiment therefore enables a user of the computer device to rapidly identify relevant search results from multiple information sources simply by gesturing on a touch screen device. Thus for example the user may identify a Star

Trek movie or episode for playing on the computing device simply by writing the letters “ST” on the touch screen. This is a considerable improvement for users over existing methods in which the user may be required to log in to a particular device such as a home entertainment system in order to search and navigate the contents of this device. Further adding to user convenience in this example, simply touching the touch screen of the computer device 12 is sufficient to wake the device from a “sleep” state and execute the multisource search without further and time consuming interaction with the device 12.

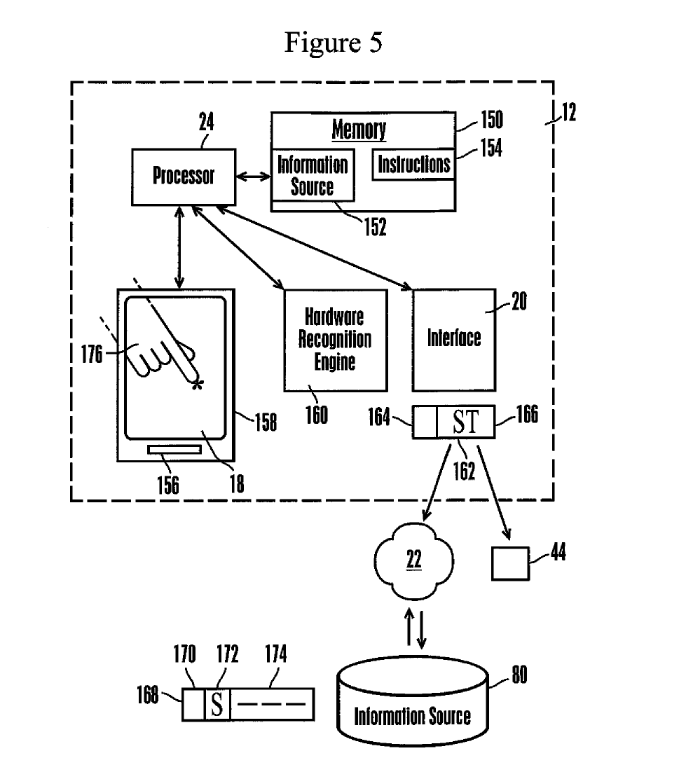

Referring now to FIG. 5, a schematic diagram illustrating operation of a system for implementing a search using handwriting to invoke a multi window search results screen is shown. The computing device 12 of FIG. 1 is shown with certain component highlighted together with additional components for interacting with various information sources in accordance with present principals. The processor 24, touch screen display 18, and network interface 20 of the computing device 12 are illustrated. In addition a handwriting recognition engine 160 and onboard memory 150 are schematically illustrated. The memory 150 may comprise an information source 152 such as an address book for example. In addition the memory may contain software code instructions 154 for execution by the processor 24 in order to implement the search using handwriting to invoke multi window search results screen. The memory 150 may be any suitable combination of volatile and non-volatile memory such as RAM, Flash memory, and BIOS ROM for example. Remote information sources are also shown at 44 and 80.

The device 12 may be configured such that is in a reduced power or sleep state, an initial user input establishes an increased power state. The initial user input may include touching the touch screen display 18 with a hand or finger 176 as shown. Alternatively, user finger proximity may be sufficient to trigger the increased power state. Further alternatives include the use of a stylus, activating a physical button 156 on the device, or employing a sliding contact along an active bezel 158 of the device for example. Following establishment of the increased power state, the device 12 can be configured to enter a multi-window search mode as previously described in which recognition of user input at the touch screen 18 causes querying of one or more information sources. Alternatively this multi-window search mode may be activated using an appropriate menu selection or other user command.

Further user input at the touch screen is processed by the handwriting recognition engine 160 which may be implemented in software or hardware using commercially available solutions. As each symbol is recognized, this is added to a new query together with any previously recognized symbols. As shown the query may be implemented using a network message 162 transmitted and/or received by the network interface module 20. Typically network messages will include an address portion 164 which in this example will be addressed to one or more information sources 44, 80. A payload portion contains the recognized symbols 166. A response message from one of the information sources 80 is shown being forwarded back to the computer device 12. This response message 168 in this example is another network message which includes an address portion containing the network address of the computer device. The payload may include the symbols 172 associated with the query together with the query response data 174 which may include contents similar to that shown in FIGS. 3 and 4. Once received by the network interface 20, this response message 168 has its payload data forwarded to the processor 24 for processing in order to display at least a portion of this data in one of the multiple windows or partitions 134, 138, 140, and as illustrated in FIG. 3, 4.

The above methods may be implemented as software instructions executed by a processor, suitably configured application specific integrated circuits (ASIC) or field programmable gate array (FPGA) modules, or any other convenient manner as would be appreciated by those skilled in those art. Where employed, the software instructions may be embodied in a non-transitory device such as a CD Rom or Flash drive. The software code instructions may alternatively be embodied in a transitory arrangement such as a radio or optical signal, or via a download over the internet.

It will be appreciated that whilst present principals have been described with reference to some example embodiments, these are not intended to be limiting, and that various alternative arrangements may be used to implement the subject matter claimed herein.

What is claimed is:

1. A computer device comprising:
at least one computer readable storage medium bearing instructions executable by a processor;
at least one processor configured for accessing the computer readable storage medium to execute the instructions to configure the processor for:
establishing a reduced power state of the device;
receiving gesture signals from a display of the device;
responsive to the gesture signals, establishing an increased power state of the device;
responsive to the gesture signals, generating a query;
sending the query to at least a first source of information; and
presenting at least portions of a response to the query from the first source of information on the display.

2. The device of claim 1, wherein the instructions when executed by the processor configure the processor for:
sending the query to at least a second source of information; and
presenting at least portions of a response to the query from the second source of information on the display, the portions of the response to the query from the first source of information being presented in a first partition on the display and the portions of the response to the query from the second source of information being presented in a second partition on the display different from the first partition.

3. The device of claim 1, wherein the instructions when executed by the processor configure the processor for:
sending the query to at least a third source of information; and
presenting at least portions of a response to the query from the third source of information on the display.

4. The device of claim 1, wherein the first source of information is the Internet.

5. The device of claim 2, wherein the second source of information is a digital data storage element in the device.

6. The device of claim 3, wherein the third source of information is a database of computer software applications.

7. A computer device comprising:
at least one computer readable storage medium bearing instructions executable by a processor;
at least one processor configured for accessing the computer readable storage medium to execute the instructions to configure the processor for:
presenting on a display of the device a user interface (UI) presenting search results from plural sources of information in respective windows on the display responsive to a query sent to the sources of information, at least a first source being the Internet and at least a second source being an internal data storage of the device.

8. The device of claim 7, wherein the instructions when executed by the processor configure the processor for:
establishing a reduced power state of the device;
receiving gesture signals from the display;
responsive to the gesture signals, establishing an increased power state of the device;
responsive to the gesture signals, generating a query; and
sending the query to the plural sources of information.

9. The device of claim 8, wherein the instructions when executed by the processor configure the processor for:
sending the query to at least a three sources of information; and
presenting at least portions of responses to the query from three sources in respective windows on the display.

10. The device of claim 7, wherein a first source of information is the Internet.

11. The device of claim 7, wherein a second source of information is a digital data storage element in the device.

12. The device of claim 9, wherein a third source of information is a database of computer software applications.

13. A method of operating a computer device having a processor, a memory, and a touchscreen display; the method comprising:
establishing an increased power state of the device in response to an initial user input;
generating a query in response to received user input at the touchscreen;
sending the query to a source of source of information;
receiving a response to the query from the source of information;
displaying a portion of the response on the display.

14. The method of claim 13, wherein the initial user input is user input at the touchscreen.

15. The method of claim 13, wherein generating a query comprises performing handwriting recognition on user input at the touchscreen display in order to recognize one or more symbols.

16. The method of claim 15, wherein one or more further queries are generated and sent in response to recognizing each of a number of additional symbols.

17. The method of claim 13, wherein the or each query is sent to a plurality of sources of information and wherein a portion of a response received from each source of information is displayed in a respective partition of the display.
